(19) United States
(12) Patent Application Publication
(10) Pub. No.: US 2026/0135325 A1
(43) Pub. Date: May 14, 2026

(54) SHELL AND CONNECTOR

(71) Applicant: Yazaki Corporation, Tokyo (JP)

(72) Inventors: Toshiya Nishimoto, Makinohara-shi (JP); Hideto Kumakura, Makinohara-shi (JP); Ayumu Ishikawa, Fujieda-shi (JP); Yuki Hiruta, Fujieda-shi (JP)

(21) Appl. No.: 19/384,277

(22) Filed: Nov. 10, 2025

(30) Foreign Application Priority Data
Nov. 11, 2024 (JP) 2024-196423

(51) Int. Cl. H01R 13/512

(52) U.S. Cl. CPC H01R 13/512; H01R 2201/26

(57) ABSTRACT

A shell is used for being attached to a housing. The housing includes a terminal accommodating portion accommodating a terminal, a conductive member accommodating portion disposed adjacent to the terminal accommodating portion so as to be immovable and accommodates a part of a conductive member extending from the terminal, and an opening opening the terminal accommodating portion and the conductive member accommodating portion to an outside in a first intersecting direction intersecting an arrangement direction of the terminal accommodating portion and the conductive member accommodating portion. The shell includes: a first shell that covers, among the opening, at least a first opening corresponding to the terminal accommodating portion; and a second shell that covers, among the opening, at least a second opening corresponding to the conductive member accommodating portion. The first and second shells are rotatable relative to each other about an axis extending in the first intersecting direction.

### BACKGROUND OF THE INVENTION

Field of the Invention

An embodiment of the present invention relates to a shell and a connector.

Priority is claimed on Japanese Patent Application No. 2024-196423 filed in Japan on Nov. 11, 2024, the content of which is incorporated herein by reference.

### Description of Related Art

A connector including a terminal, a housing that accommodates the terminal and a conductive member (a bus bar or an electric wire) extending from the terminal, and a shell that covers an opening of the housing is known. The opening of the housing is a portion of the housing that opens both an accommodating portion for the terminal (terminal accommodating portion) and an accommodating portion for the conductive member (conductive member accommodating portion) in the housing to the outside.

### PRIOR ART DOCUMENT

### Patent Document

Patent Document 1: Japanese Unexamined Patent Application, First Publication No. 2022-151014

### SUMMARY OF THE INVENTION

In such a type of connector, a direction of the conductive member extending from the terminal inside the housing (an extending direction of the conductive member) may change depending on an application. Due to such circumstances, a plurality of types of housings having different extending directions of the conductive member accommodating portion with respect to the terminal accommodating portion are prepared according to various applications of the connector. Hitherto, since a plurality of types of shells respectively corresponding to the plurality of types of housings are prepared, a manufacturing cost of the connector including the housing and the shell becomes high.

One embodiment provides a shell and a connector capable of reducing a manufacturing cost of the connector.

A shell according to one embodiment is a shell for being attached to a housing. The housing includes a terminal accommodating portion that accommodates a terminal, a conductive member accommodating portion that is disposed adjacent to the terminal accommodating portion so as to be immovable and accommodates a part of a conductive member extending from the terminal, and an opening that opens the terminal accommodating portion and the conductive member accommodating portion to an outside in a first intersecting direction intersecting an arrangement direction of the terminal accommodating portion and the conductive member accommodating portion. The shell includes: a first shell that covers, among the opening, at least a first opening corresponding to the terminal accommodating portion; and a second shell that covers, among the opening, at least a second opening corresponding to the conductive member accommodating portion. The first shell and the second shell are rotatable relative to each other about an axis extending in the first intersecting direction. The shell further includes a fixing portion that unrotatably fixes the first shell and the second shell to each other at a position away from the axis in a radial direction.

A connector according to one embodiment includes: a terminal; a housing including a terminal accommodating portion that accommodates the terminal, a conductive member accommodating portion that is disposed adjacent to the terminal accommodating portion so as to be immovable and accommodates a part of a conductive member extending from the terminal, and an opening that opens the terminal accommodating portion and the conductive member accommodating portion to an outside in a first intersecting direction intersecting an arrangement direction of the terminal accommodating portion and the conductive member accommodating portion; and the abovementioned shell.

With the shell and the connector according to one embodiment of the present invention, the manufacturing cost of the connector can be reduced.

### BRIEF DESCRIPTION OF THE DRAWINGS

FIG. 1 is a perspective view of a routing unit including a connector according to a first embodiment when viewed from a front side.

FIG. 2 is an exploded perspective view of a state in which a shell is detached from a housing in the connector according to the first embodiment when viewed from the front side.

FIG. 3 is an exploded perspective view of a state in which the shell is detached from the housing in the connector according to the first embodiment when viewed from a rear side.

FIG. 4 is an exploded perspective view of the shell illustrated in FIGS. 2 and 3 when viewed from the front side.

FIG. 5 is a front view of the shell illustrated in FIGS. 2 and 3 when viewed from the front side.

FIG. 6 is a front view of a state in which a second shell is rotated with respect to a first shell in the shell illustrated in FIG. 5 when viewed from the front side.

FIG. 7 is an exploded perspective view of a shell of a second embodiment when viewed from a front side.

FIG. 8 is a front view of the shell illustrated in FIG. 7 when viewed from the front side.

FIG. 9 is a front view of a state in which a second shell is rotated with respect to a first shell in the shell illustrated in FIG. 8 when viewed from the front side.

### DETAILED DESCRIPTION OF THE INVENTION

Hereinafter, embodiments will be described with reference to the drawings. In the following description, constitutions having the same or similar functions are denoted by the same reference numbers. Redundant descriptions of these constitutions may be omitted.

In the present disclosure, the terms are defined as follows. The term “connection” is not limited to a mechanical connection, and may include an electrical connection. Further, the term “connection” is not limited to a case where two elements that are connection targets are directly connected, and may include a case where two elements that are connection targets are connected with another element interposed therebetween. The term “to restrict” is not limited to a case where two members are in constant contact with each other, thereby restricting movement of one member with respect to the other member. The term “to restrict” may include, for example, a case where two members are not in contact with each other in a state in which no positional shift occurs, but the two members are brought into contact with each other when one of the two members is caused to be shifted with respect to the other, thereby restricting movement of one of the two members with respect to the other. In addition, “to restrict” means that movement in at least one direction is restricted.

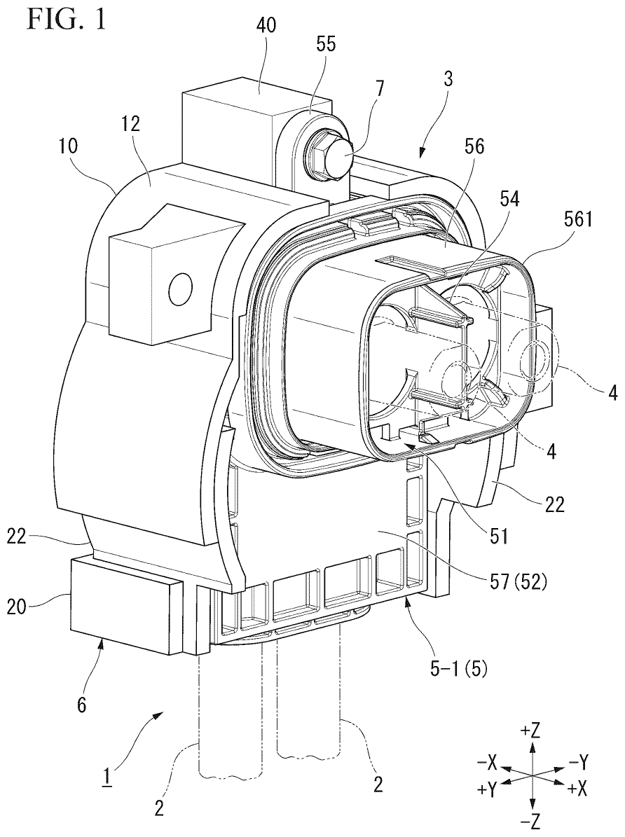

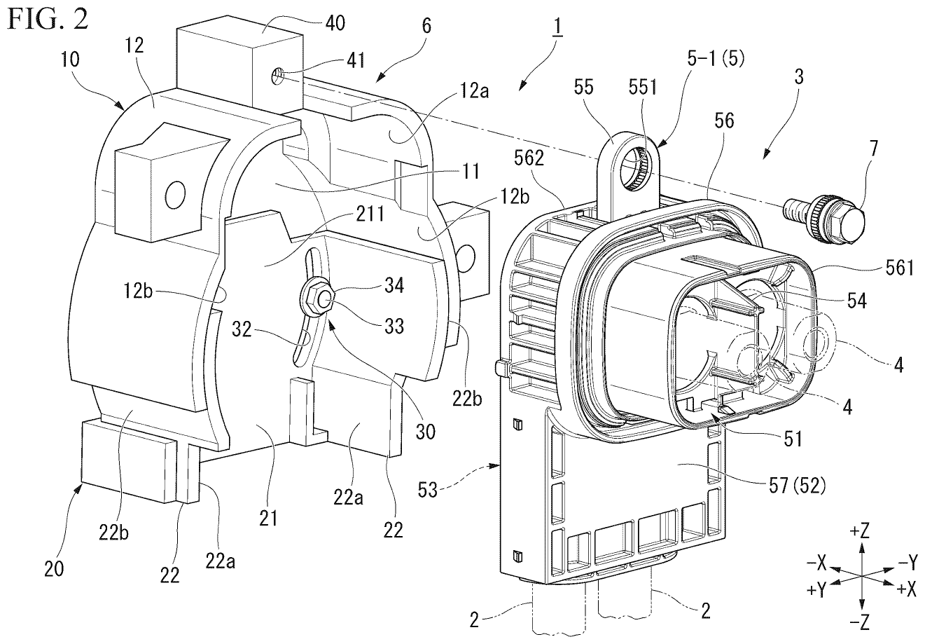

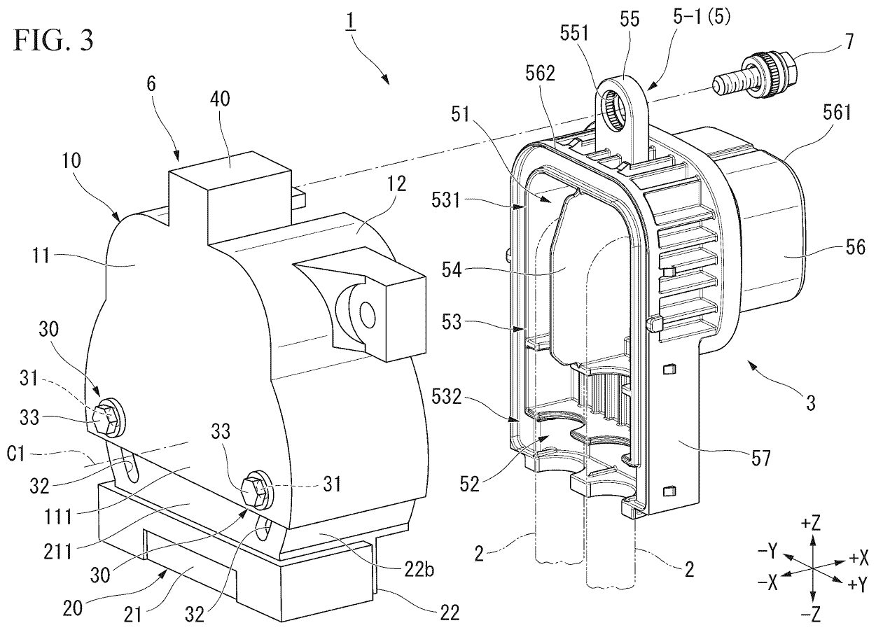

In the present disclosure, a +X direction, a −X direction, a +Y direction, a −Y direction, a +Z direction, and a −Z direction are defined as follows. The +X direction is a direction in which a shell 6 and a housing 5 of a connector 3 are arranged in order (see FIGS. 1 to 3). The −X direction is a direction opposite to the +X direction. When the +X direction and the −X direction are not distinguished from each other, they are simply referred to as “X direction”. The Y direction is a direction intersecting (for example, orthogonal to) the X direction. The +Y direction is a direction from one of two terminals 4 of the connector 3 to the other (See FIGS. 1 and 2). The −Y direction is a direction opposite to the +Y direction. When the +Y direction and the −Y direction are not distinguished from each other, they are simply referred to as “Y direction”. The +Z direction is a direction intersecting (for example, orthogonal to) the X direction and the Y direction. The +Z direction is a direction in which a conductive member accommodating portion 52 and a terminal accommodating portion 51 of the housing 5 are arranged in order (see FIG. 3). The −Z direction is a direction opposite to the +Z direction. When the +Z direction and the −Z direction are not distinguished from each other, they are simply referred to as “Z direction”. The Z direction is an example of an “arrangement direction of the terminal accommodating portion 51 and the conductive member accommodating portion 52”. The X direction is an example of a “first intersecting direction” intersecting the arrangement direction. In addition, hereinafter, for convenience of description, the +X-direction side may be referred to as a “front side”, and a −X-direction side may be referred to as a “rear side”.

### First Embodiment

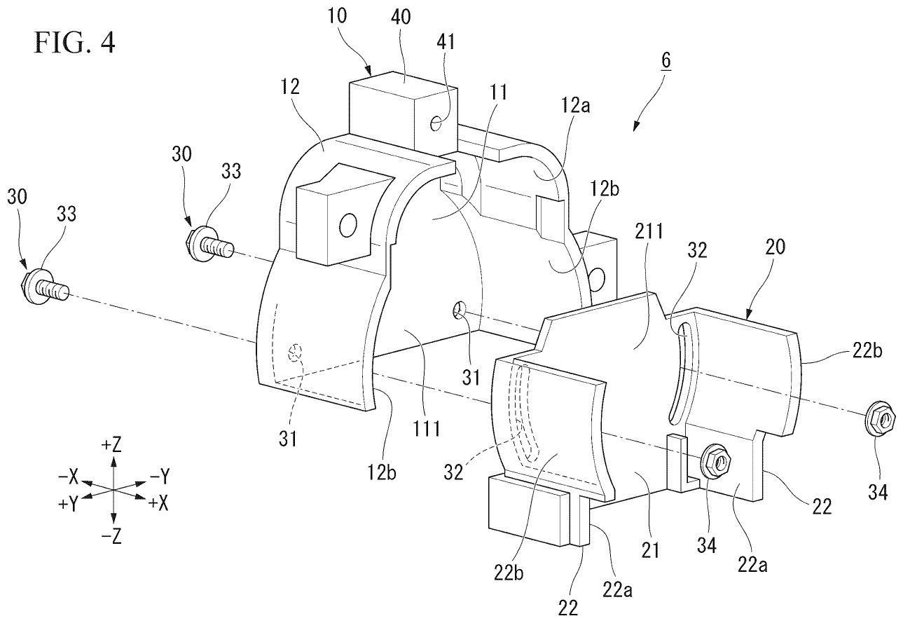

A first embodiment will be described with reference to FIGS. 1 to 6.

### Connector

As illustrated in FIGS. 1 to 3, the connector 3 of the first embodiment is a component for electrically connecting an electric wire 2 to a mating connector (not illustrated). The connector 3 is, for example, a connector 3 used for a vehicle such as an electric vehicle (EV), a hybrid electric vehicle (HEV), or a plug-in hybrid electric vehicle (PHEV). The connector 3 is, for example, a high-voltage connector in which a current of 100 V or higher flows. The connector 3 of the present embodiment is a connector 3 corresponding to two electrodes. However, the connector 3 may be, for example, a connector 3 corresponding to one electrode or a connector 3 corresponding to three or more electrodes.

The connector 3 includes the terminal 4, the housing 5, and the shell 6. The connector 3 constitutes the routing unit 1 together with the electric wire 2 (conductive member) connected to the terminal 4 of the connector 3.

### Terminal

The terminal 4 is accommodated in the terminal accommodating portion 51 of the housing 5 described below. In the connector 3 illustrated in FIGS. 1 and 2, two terminals 4 are arranged in the Y direction in the terminal accommodating portion 51. The number of terminals 4 in the connector 3 is not limited to two, and may be any number. In addition, the arrangement of the plurality of terminals 4 in the terminal accommodating portion 51 may be arbitrary.

### Housing

As illustrated in FIGS. 2 and 3, the housing 5 is made of a material having an electrical insulation property (for example, a synthetic resin material). The housing 5 includes the terminal accommodating portion 51, the conductive member accommodating portion 52, an opening 53, an insulating wall 54, and an attaching portion 55.

### Terminal Accommodating Portion

The terminal accommodating portion 51 is a space in the housing 5, the space accommodating the terminal 4 described above. The terminal accommodating portion 51 of the present embodiment is a space inside a tubular portion 56 extending in the X direction and having both ends opened. With such a configuration, the terminal accommodating portion 51 is opened to a first end 561 side of the tubular portion 56 positioned on the front side (+X direction side) and a second end 562 side of the tubular portion 56 positioned on the rear side (−X direction side).

A portion of the tubular portion 56 on the first end 561 side is a fitted portion to be fitted to the mating connector. The terminal 4 accommodated in the terminal accommodating portion 51 is exposed to the outside of the housing 5 through an opening of the tubular portion 56 on the first end 561 side. With such a configuration, the terminal 4 is connected to a terminal (not illustrated) of the mating connector in a state in which the portion of the tubular portion 56 on the first end 561 side is fitted to the mating connector.

An opening of the tubular portion 56 on the second end 562 side is a first opening 531 that opens the terminal accommodating portion 51 to the outside from the rear side (−X direction side).

### Conductive Member Accommodating Portion

As illustrated in FIG. 3, the conductive member accommodating portion 52 (an accommodating portion for the electric wire 2) is a space in the housing 5, the space accommodating a part of the electric wire 2 (conductive member) extending from the terminal 4 accommodated in the terminal accommodating portion 51. The conductive member accommodating portion 52 is disposed adjacent to the terminal accommodating portion 51 so as to be immovable. A proximal end portion of the electric wire 2, which is adjacent to the terminal 4, is accommodated in the conductive member accommodating portion 52, and a portion of the electric wire 2 that further extends from the proximal end portion is led out to the outside of the conductive member accommodating portion 52. In the following description, a direction in which the electric wire 2 extends in the conductive member accommodating portion 52 may be referred to as an “extending direction of the conductive member accommodating portion 52”.

The conductive member accommodating portion 52 of the present embodiment is a space inside a guide portion 57 that guides the electric wire 2 extending from the terminal 4 in a predetermined direction. The guide portion 57 is formed integrally with the tubular portion 56. That is, the tubular portion 56 and the guide portion 57 are fixed so as not to move relative to each other. The guide portion 57 is connected to a portion of the tubular portion 56 on the second end 562 side. With such a configuration, the conductive member accommodating portion 52 communicates with the terminal accommodating portion 51 on the second end 562 side of the tubular portion 56.

In the present embodiment, the guide portion 57 extends from the tubular portion 56 in a direction intersecting the X direction (for example, a direction orthogonal to the X direction). The guide portion 57 guides the electric wire 2 in a direction in which the guide portion 57 extends from the tubular portion 56. The extending direction of the guide portion 57 corresponds to the extending direction of the conductive member accommodating portion 52. In the housing 5 illustrated in FIG. 3, the guide portion 57 extends in the −Z direction with respect to the tubular portion 56. In the housing 5, for example, the guide portion 57 may extend obliquely toward a −Y direction side or a +Y direction side as it goes toward the −Z direction with respect to the tubular portion 56 when viewed from the X direction.

The guide portion 57 has a second opening 532 that opens the conductive member accommodating portion 52 to the outside of the housing 5 from the rear side (−X direction side).

The opening 53 of the housing 5 opens the terminal accommodating portion 51 and the conductive member accommodating portion 52 described above to the outside in the −X direction (first intersecting direction). The opening 53 includes the first opening 531 and the second opening 532 described above.

### Insulating Wall

As illustrated in FIGS. 2 and 3, the insulating wall 54 is positioned between the adjacent terminals 4 in the terminal accommodating portion 51 to electrically insulate the adjacent terminals 4 from each other. Specifically, the insulating wall 54 is positioned between the terminals 4 adjacent to each other in the Y direction in the terminal accommodating portion 51. The insulating wall 54 is formed in a shape extending in the X direction and the Z direction with the Y direction as a thickness direction.

### Attaching Portion

The attaching portion 55 is a portion of the housing 5 for fixing the shell 6 to the housing 5. In the present embodiment, the attaching portion 55 has an attachment hole 551 through which a shaft portion of an attachment bolt 7 used for attaching the shell 6 passes. The attaching portion 55 is positioned on the second end 562 side of the tubular portion 56 and protrudes from the tubular portion 56 in a direction intersecting the X direction (the +Z direction in the illustrated example). The attachment hole 551 penetrates through the attaching portion 55 in the X direction. In the present embodiment, the attaching portion 55 is formed integrally with the tubular portion 56 constituting the terminal accommodating portion 51 and is positioned away from the guide portion 57 constituting the conductive member accommodating portion 52.

### Shell

As illustrated in FIG. 1, the shell 6 is attached to the housing 5 to cover the opening 53 (see FIG. 3) of the housing 5. As illustrated in FIGS. 1 to 3, the shell 6 includes a first shell 10, a second shell 20, a fixing portion 30, and an attached portion 40. The first shell 10 and the second shell 20 are made of a material having an electrical insulation property (for example, a synthetic resin material).

The first shell 10 covers, in the opening 53 of the housing 5, at least the first opening 531 (see FIG. 3) corresponding to the terminal accommodating portion 51. The second shell 20 covers, in the opening 53 of the housing 5, at least the second opening 532 (see FIG. 3) corresponding to the conductive member accommodating portion 52. As illustrated in FIGS. 3, 5, and 6, the first shell 10 and the second shell 20 are rotatable relative to each other about an axis C1 extending in the X direction (first intersecting direction). The fixing portion 30 unrotatably fixes the first shell 10 and the second shell 20 to each other at a position away from the axis C1 in a radial direction. The fixing portion 30 fixes the first shell 10 and the second shell 20 to each other at an arbitrary rotational position.

Hereinafter, the configuration of the shell 6 of the present embodiment will be further described.

As illustrated in FIGS. 2 to 5, the first shell 10 and the second shell 20 are arranged in order in the −Z direction. A portion of the first shell 10 on a −Z direction side and a portion of the second shell 20 on a +Z direction side overlap each other in the X direction.

### First Shell

The first shell 10 of the present embodiment includes a first cover portion 11 and a first side wall 12. The first cover portion 11 is formed in a plate shape with the X direction as a plate thickness direction. The first cover portion 11 mainly covers the first opening 531 (see FIG. 3) of the tubular portion 56 (terminal accommodating portion 51). A portion of the first cover portion 11 on the −Z direction side is a first overlapping portion 111 overlapping a second cover portion 21 of the second shell 20 described below in the X direction.

The first side wall 12 extends in the +X direction (one side in the plate thickness direction of the first cover portion 11) from a part of a peripheral edge of the first cover portion 11. The first side wall 12 is positioned at a portion of the peripheral edge of the first cover portion 11 excluding an edge portion on the −Z direction side, which is adjacent to the second shell 20. In other words, an opening is formed at a portion of the first side wall 12 on the −Z direction side, the first side wall 12 being provided on the peripheral edge of the first cover portion 11.

As illustrated in FIGS. 2, 4, and 5, the first side wall 12 has a first inner side surface 12a and an arc-shaped inner surface (arcuate inner surface) 12b.

The first inner side surface 12a is a surface that faces and covers a part of an outer periphery of the tubular portion 56 in a state in which the shell 6 is attached to the housing 5. In the present embodiment, the first inner side surface 12a is formed at a portion of the first side wall 12 on the +Z direction side. The first inner side surface 12a is formed in a recessed shape recessed toward the +Z direction side when viewed from the X direction.

The arc-shaped inner surface 12b is a surface centered on the axis C1 which is a relative rotation center between the first shell 10 and the second shell 20. In the present embodiment, the arc-shaped inner surface 12b is formed at a portion of the first side wall 12 adjacent to the first inner side surface 12a on the −Z direction side. Specifically, the arc-shaped inner surface 12b is formed to be continuous on the −Z direction side from each of both ends of the first inner side surface 12a having a recessed shape recessed toward the +Z direction side when viewed from the X direction. With such a configuration, the arc-shaped inner surface 12b is positioned at each of both ends of the first cover portion 11 in the Y direction. The two arc-shaped inner surfaces 12b face each other in the Y direction.

### Second Shell

As illustrated in FIGS. 2 to 5, the second shell 20 of the present embodiment includes the second cover portion 21 and a second side wall 22.

The second cover portion 21 is formed in a plate shape with the X direction as a plate thickness direction. The second cover portion 21 mainly covers the second opening 532 (see FIG. 3) of the guide portion 57 (conductive member accommodating portion 52). A portion of the second cover portion 21 on the +Z direction side is a second overlapping portion 211 overlapping the first cover portion 11 of the first shell 10 in the X direction. In the present embodiment, the second overlapping portion 211 overlaps the first overlapping portion 111 of the first cover portion 11 on the +X direction side (housing 5 side).

The second side wall 22 extends in the +X direction (one side in the plate thickness direction of the second cover portion 21) from a part of a peripheral edge of the second cover portion 21. The second side wall 22 is positioned only at an edge portion on each of both sides of the peripheral edge of the second cover portion 21 in the Y direction, and is not positioned at edge portions on both sides of the peripheral edge of the second cover portion 21 in the Z direction. In other words, openings are formed at portions of the second side wall 22 on the +Z direction side and the −Z direction side, the second side wall 22 being provided on the peripheral edge of the second cover portion 21.

An inner space of the first shell 10 and an inner space of the second shell 20 communicate with each other by forming the opening at the portion of the first side wall 12 on the −Z direction side and forming the opening at the portion of the second side wall 22 on the +Z direction side. In addition, since the opening is formed at the portion of the second side wall 22 on the −Z direction side, the electric wire 2 can be led out to the outside of the guide portion 57 (housing 5) even in a state in which the shell 6 is attached to the housing 5.

As illustrated in FIGS. 2, 4, and 5, each of the two second side walls 22 has second inner side surfaces 22a and arc-shaped outer surfaces (arcuate outer surface) 22b.

The two second inner side surfaces 22a are surfaces facing outer surfaces of the guide portion 57 that face both sides in the Y direction in a state in which the shell 6 is attached to the housing 5. In the present embodiment, each of the second inner side surfaces 22a is formed at an end portion of each of the second side walls 22 on the −Z direction side.

Each of the two arc-shaped outer surfaces 22b is a surface centered on the axis C1. In the present embodiment, each arc-shaped outer surface 22b is formed at an end portion of the second side wall 22 on the +Z direction side. The arc-shaped outer surface 22b of the second side wall 22 is in surface contact with the arc-shaped inner surface 12b of the first side wall 12 in a state in which the second shell 20 is attached to the first shell 10. When the first shell 10 and the second shell 20 are relatively rotated about the axis C1, the arc-shaped inner surface 12b and the arc-shaped outer surface 22b slide in a circumferential direction D1 about the axis C1.

### Fixing Portion

As illustrated in FIGS. 3 to 5, a plurality of fixing portions 30 are arranged at intervals in the circumferential direction D1 about the axis C1. The number of fixing portions 30 in the present embodiment is two. The two fixing portions 30 are positioned on both sides of the axis C1 in the Y direction.

Each fixing portion 30 includes an insertion hole 31, a long hole 32, a bolt 33, and a nut 34.

The insertion hole 31 is formed in the first shell 10, and a shaft portion of the bolt 33 is inserted through the insertion hole 31. Specifically, the insertion hole 31 is formed in the first overlapping portion 111 of the first cover portion 11 and penetrates through the first overlapping portion 111 in a plate thickness direction of the first overlapping portion 111. A size of the insertion hole 31 is equal to a size of the shaft portion of the bolt 33 when viewed from the X direction. The size of the insertion hole 31 when viewed from the X direction is the same as the size of the shaft portion of the bolt 33 or slightly larger than the size of the shaft portion of the bolt 33. With such a configuration, movement of the bolt 33 in a direction intersecting the X direction is restricted in a state in which the shaft portion of the bolt 33 passes through the insertion hole 31. In the present embodiment, the insertion of the bolt 33 through the insertion hole 31 of the first shell 10 means one example of attachment of the bolt 33 to the first shell 10.

The long hole 32 is formed in the second shell 20 and is formed in an arc shape extending in the circumferential direction D1 around the axis C1. Specifically, the long hole 32 is formed in the second overlapping portion 211 of the second cover portion 21, penetrates through the second overlapping portion 211 in a plate thickness direction of the second overlapping portion 211, and extends in an arc shape in the circumferential direction D1. The width dimension (width) of the long hole 32 is equal to the diameter dimension (diameter) of the shaft portion of the bolt 33 when viewed from the X direction. The width dimension (width) of the long hole 32 when viewed from the X direction is the same as the diameter dimension (diameter) of the shaft portion of the bolt 33 or slightly larger than the diameter dimension (diameter) of the shaft portion of the bolt 33. With such a configuration, movement of the bolt 33 is restricted in a width direction of the long hole 32 in a state in which the shaft portion of the bolt 33 passes through the long hole 32. The “width direction of the long hole 32” is a direction orthogonal to an extending direction of the long hole 32 when viewed from the X direction.

The insertion hole 31 and the long hole 32 constituting the same fixing portion 30 are positioned on the same circumference centered on the axis C1. With such a configuration, the insertion hole 31 and the long hole 32 can be disposed so as to overlap each other in the X direction. When the first shell 10 and the second shell 20 are relatively rotated about the axis C1, the insertion hole 31 can be moved in the extending direction (circumferential direction) of the long hole 32 in a state in which the insertion hole 31 overlaps the long hole 32.

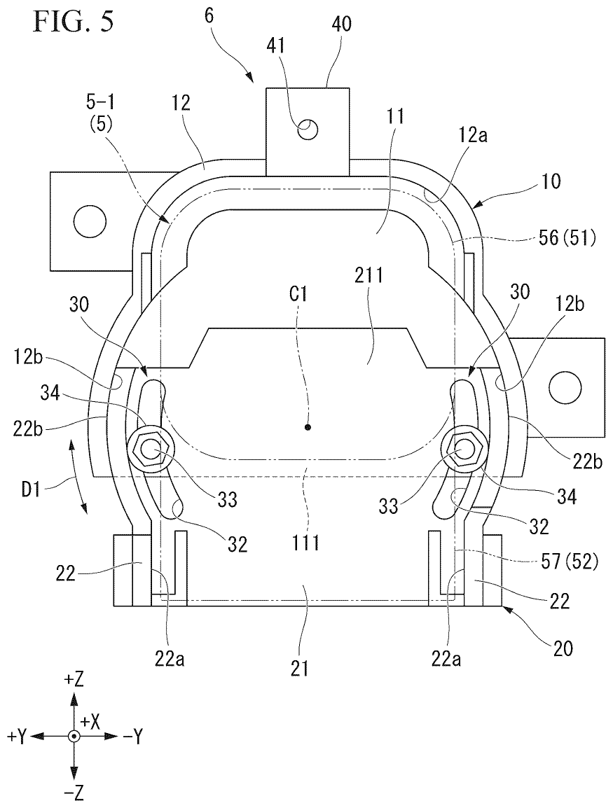

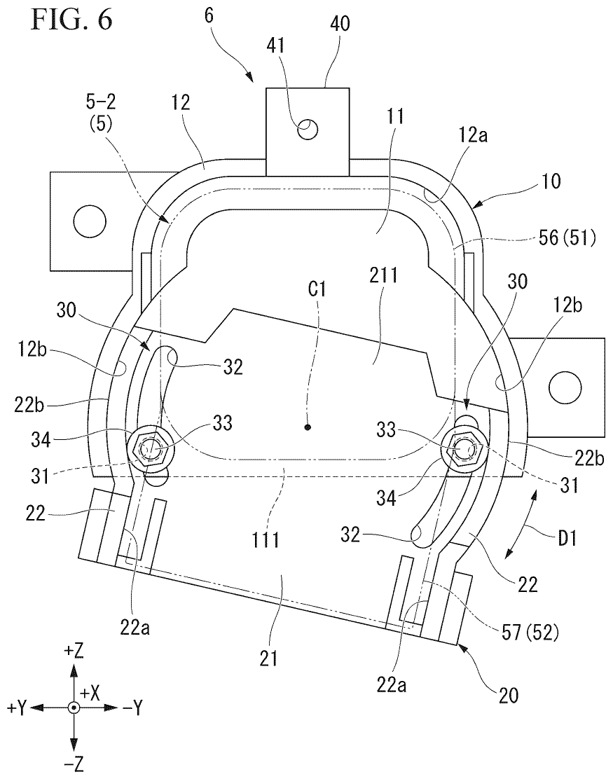

In FIGS. 5 and 6, the insertion holes 31 and the long holes 32 of the two fixing portions 30 are positioned on the same circumference. However, the insertion hole 31 and the long hole 32 of one fixing portion 30 and the insertion hole 31 and the long hole 32 of the other fixing portion 30 may be positioned on different circumferences. In other words, a distance from the axis C1 to the insertion hole 31 and the long hole 32 of one fixing portion 30 in the radial direction may be different from a distance from the axis C1 to the insertion hole 31 and the long hole 32 of the other fixing portion 30 in the radial direction.

As illustrated in FIGS. 2 to 4, the bolt 33 is inserted through the insertion hole 31 of the first shell 10 and the long hole 32 of the second shell 20, which constitute the same fixing portion 30.

The nut 34 is screwed to the bolt 33 inserted through the insertion hole 31 of the first shell 10 and the long hole 32 of the second shell 20, which constitute the same fixing portion 30, thereby unrotatably fixing the first shell 10 and the second shell 20 to each other. Specifically, the nut 34 is screwed to a distal end portion of the shaft portion of the bolt 33 inserted through the insertion hole 31 of the first shell 10 and the long hole 32 of the second shell 20 to sandwich the first shell 10 (first cover portion 11) and the second shell 20 (second cover portion 21) with a head portion of the bolt 33. By sandwiching the first shell 10 and the second shell 20 between the head of the bolt 33 and the nut 34, the first shell 10 and the second shell 20 are relatively unrotatably fixed to each other.

### Attached Portion

As illustrated in FIGS. 1 to 3, the attached portion 40 is a portion of the shell 6 for fixing the shell 6 to the housing 5. The attached portion 40 is adjacent to the attaching portion 55 of the housing 5 on the −X direction side in a state in which the shell 6 is attached to the housing 5. In the present embodiment, the attached portion 40 includes a female screw 41 to which the shaft portion of the attachment bolt 7 is screwed. The attached portion 40 is integrally formed with the first shell 10. The attached portion 40 protrudes in a direction (the +Z direction in the illustrated example) intersecting the X direction from an outer surface of the first side wall 12 of the first shell 10.

Since the shell 6 includes the attached portion 40 described above, the shell 6 can be fixed to the housing 5 as follows. First, the shell 6 is attached to the housing 5, and the attached portion 40 of the shell 6 is disposed adjacent to the attaching portion 55 of the housing 5 on the −X direction side. Thereafter, the shaft portion of the attachment bolt 7 passes through the attachment hole 551 of the attaching portion 55 and then is screwed to the female screw of the attached portion 40, whereby the attached portion 40 of the shell 6 is fixed to the attaching portion 55 of the housing 5. The shell 6 is fixed to the housing 5 by fixing the attached portion 40 to the attaching portion 55.

### Advantages

According to the first embodiment, the shell 6 covering the opening 53 of the housing 5 includes the first shell 10 that covers at least the first opening 531 corresponding to the terminal accommodating portion 51 in the opening 53 and the second shell 20 that covers at least the second opening 532 corresponding to the conductive member accommodating portion 52 in the opening 53. The first shell 10 and the second shell 20 are rotatable relative to each other about the axis C1 extending in the X direction (first intersecting direction). That is, a direction in which the second shell 20 corresponding to the conductive member accommodating portion 52 extends with respect to the first shell 10 corresponding to the terminal accommodating portion 51 can be changed.

With such a configuration, it is possible to attach the same type of shell 6 to a plurality of types of housings 5 having different extending directions of the conductive member accommodating portion 52 with respect to the terminal accommodating portion 51. For example, the same type of shell 6 can be attached to a housing 5-1 of a first example illustrated in FIGS. 1 to 3, and 5 and a housing 5-2 of a second example illustrated in FIG. 6. This point will be described below.

As illustrated in FIG. 5, in the housing 5-1 of the first example, the guide portion 57 including the conductive member accommodating portion 52 extends in the −Z direction with respect to the tubular portion 56 including the terminal accommodating portion 51. In order to attach the shell 6 to the housing 5-1 of the first example, the relative rotational position between the first shell 10 and the second shell 20 is set such that the second shell 20 extends in the −Z direction with respect to the first shell 10. By setting the relative rotational position between the first shell 10 and the second shell 20 in this manner, the shell 6 can be attached to the housing 5-1 of the first example.

On the other hand, as illustrated in FIG. 6, in the housing 5-2 of the second example, the guide portion 57 including the conductive member accommodating portion 52 extends in an inclined direction inclined toward the +Y direction side as it goes toward the −Z direction with respect to the tubular portion 56 including the terminal accommodating portion 51. In order to attach the shell 6 to the housing 5-2 of the second example, the relative rotational position between the first shell 10 and the second shell 20 is set such that the second shell 20 extends in the above-described “inclined direction” with respect to the first shell 10. By setting the relative rotational position between the first shell 10 and the second shell 20 in this manner, the shell 6 can be attached to the housing 5-2 of the second example.

As described above, since the same type of shell 6 is compatible with various types of housings 5, versatility of the shell 6 can be improved. Therefore, a manufacturing cost of the connector 3 including the housing 5 and the shell 6 can be reduced.

According to the first embodiment, the shell 6 further includes the fixing portion 30 that unrotatably fixes the first shell 10 and the second shell 20 to each other.

With such a configuration, the shell 6 can be easily attached to the housing 5 in a state in which the first shell 10 and the second shell 20 are held at desired rotational positions by the fixing portion 30.

According to the first embodiment, the fixing portion 30 unrotatably fixes the first shell 10 and the second shell 20 to each other at a position away from the axis in the radial direction.

With such a configuration, the relative rotation between the first shell 10 and the second shell 20 can be prevented even if a force for fixing the first shell 10 and the second shell 20 by the fixing portion 30 is small as compared with a case where the fixing portion 30 is positioned on the axis. Therefore, the first shell 10 and the second shell 20 can be firmly fixed to each other.

According to the first embodiment, the plurality of fixing portions 30 are arranged at intervals in the circumferential direction around the axis.

With such a configuration, the first shell 10 and the second shell 20 can be more firmly fixed to each other as compared with a case where there is one fixing portion 30.

According to the first embodiment, the fixing portion 30 includes the arc-shaped long hole 32 formed in the second shell 20 and extending in the circumferential direction about the axis, the bolt 33 attached to the first shell 10 and inserted through the long hole 32, and the nut 34 screwed to the bolt 33 attached to the first shell 10 and inserted through the long hole 32 to unrotatably fix the first shell 10 and the second shell 20 to each other.

In such a configuration, in a state in which the bolt 33 attached to the first shell 10 is inserted through the long hole 32 of the second shell 20, a relative rotation range between the first shell 10 and the second shell 20 can be limited by a length of the long hole 32 in the extending direction (the length of the long hole 32 in the circumferential direction D1). Since the relative rotation range between the first shell 10 and the second shell 20 is limited by the long hole 32, it is not necessary to add a dedicated configuration for limiting the relative rotation range between the first shell 10 and the second shell 20 separately from the fixing portion 30. Therefore, the shell 6 having a function of limiting the relative rotation range between the first shell 10 and the second shell 20 can have a simple configuration.

According to the first embodiment, the first shell 10 has the arc-shaped inner surface 12b centered on the axis C1, and the second shell 20 has the arc-shaped outer surface 22b centered on the axis C1. The arc-shaped inner surface 12b and the arc-shaped outer surface 22b come into surface contact with each other and slide in the circumferential direction D1 about the axis C1.

With such a configuration, the first shell 10 and the second shell 20 can be relatively rotated smoothly and stably. In addition, relative rattling between the first shell 10 and the second shell 20 can be suppressed or prevented, and the integrity and strength of the entire shell 6 can be secured.

Further, since the arc-shaped inner surface 12b and the arc-shaped outer surface 22b are in surface contact with each other, it is possible to suppress or prevent generation of a gap between the first shell 10 and the second shell 20 regardless of the relative rotational position between the first shell 10 and the second shell 20. As a result, it is possible to suppress or prevent the terminal accommodating portion 51 and the conductive member accommodating portion 52 of the housing 5 from communicating with the outside due to the gap between the first shell 10 and the second shell 20.

### Modification Example

In the above-described embodiment, the bolt 33 constituting the fixing portion 30 is inserted through the insertion hole 31 of the first shell 10 and the long hole 32 of the second shell 20. However, it is sufficient if the bolt 33 is attached to at least the first shell 10 and inserted through the long hole 32 of the second shell 20, and the bolt 33 may be provided integrally with the first shell 10, for example. In such a configuration, the first shell 10 does not include the insertion hole 31 for the bolt 33.

In the above-described embodiment, the long hole 32 constituting the fixing portion 30 is formed in the second shell 20. However, the long hole 32 may be formed in the first shell 10, for example. In such a configuration, the insertion hole 31 for the bolt 33 may be formed in the second shell 20, or the bolt 33 may be provided integrally with the second shell 20.

### Second Embodiment

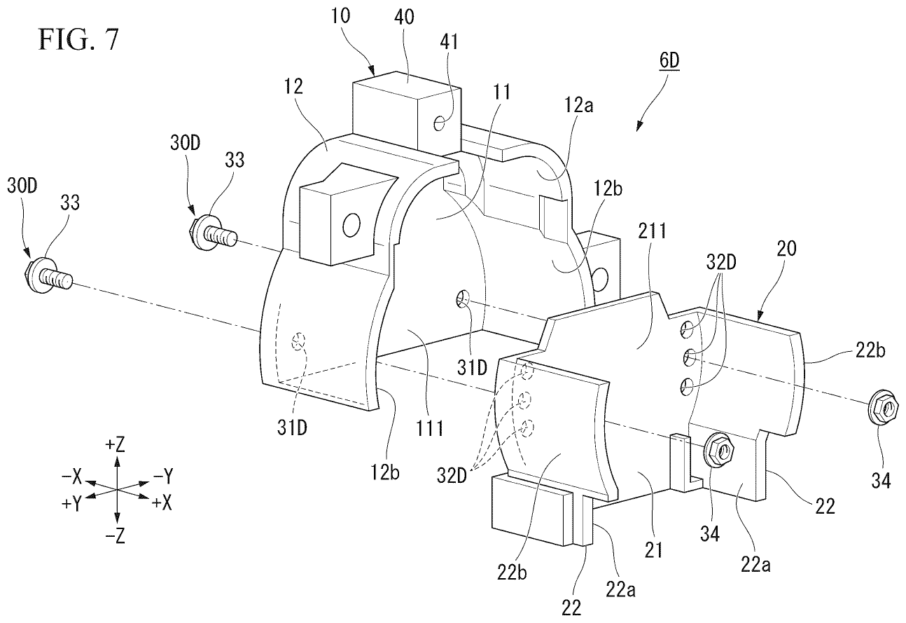

Hereinafter, a second embodiment will be described with reference to FIGS. 7 to 9. A shell 6D according to the second embodiment has the same configuration as the shell 6 according to the first embodiment except for the following points, and exhibits the same operation and effect.

In the shell 6 according to the first embodiment, the fixing portion 30 includes the long hole 32 formed in the second shell 20, whereas in the shell 6D according to the second embodiment, a fixing portion 30D includes a plurality of insertion holes 32D formed in a second shell 20.

### Fixing Portion

As illustrated in FIGS. 7 to 9, a plurality of fixing portions 30D are arranged at intervals in a circumferential direction D1 as in the first embodiment. The number of fixing portions 30D in the present embodiment is two. The two fixing portions 30D are positioned on both sides of an axis C1 in the Y direction.

Each fixing portion 30D includes a first insertion hole 31D, the plurality of second insertion holes 32D, a bolt 33, and a nut 34.

The first insertion hole 31D is the same as the “insertion hole 31” of the first embodiment. Also in the present embodiment, insertion of the bolt 33 through the first insertion hole 31D of a first shell 10 means one example of attachment of the bolt 33 to the first shell 10.

The plurality of second insertion holes 32D are formed in the second shell 20 and arranged at intervals in the circumferential direction D1 centered on the axis C1. Each of the second insertion holes 32D is formed in a second overlapping portion 211 of a second cover portion 21 and penetrates through the second overlapping portion 211 in a plate thickness direction of the second overlapping portion 211. A size of each of the second insertion holes 32D is equal to a size of a shaft portion of the bolt 33 when viewed from the X direction. The size of the second insertion hole 32D when viewed from the X direction is the same as the size of the shaft portion of the bolt 33 or slightly larger than the size of the shaft portion of the bolt 33. With such a configuration, movement of the bolt 33 in a direction intersecting the X direction is restricted in a state in which the shaft portion of the bolt 33 passes through the second insertion hole 32D.

In FIGS. 7 to 9, the number of second insertion holes 32D constituting the same fixing portion 30D is three, but may be, for example, two or four or more.

The first insertion hole 31D and the plurality of second insertion holes 32D constituting the same fixing portion 30D are positioned on the same circumference centered on the axis C1. With such a configuration, the first insertion hole 31D and the second insertion hole 32D can be disposed so as to overlap each other in the X direction. When the first shell 10 and the second shell 20 are relatively rotated about the axis C1, the second insertion hole 32D overlapping the first insertion hole 31D changes.

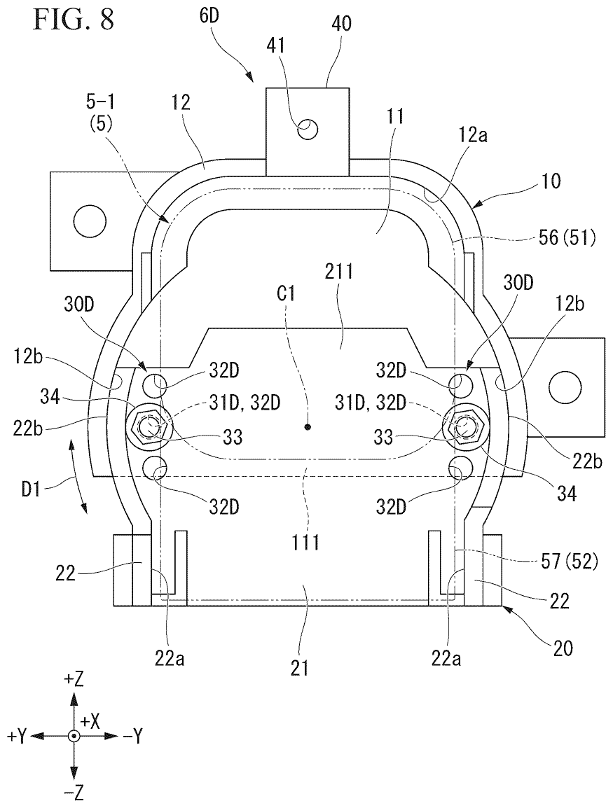

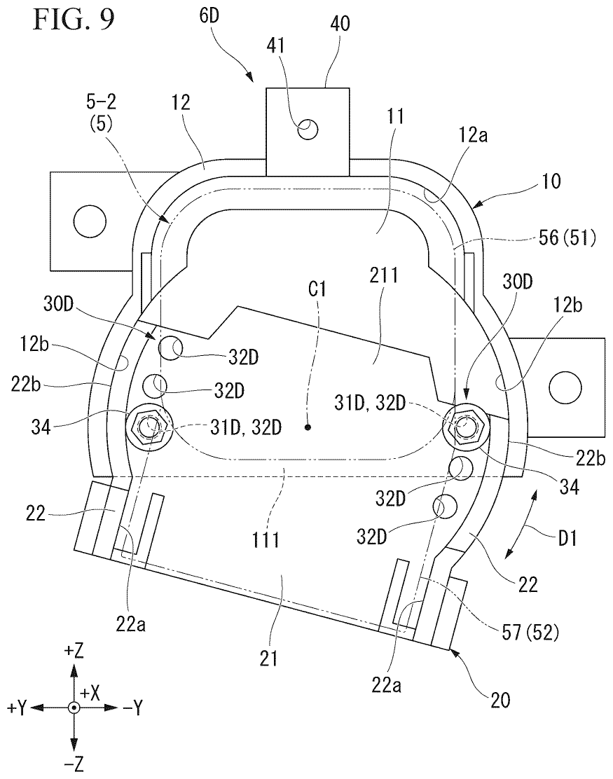

In FIGS. 8 and 9, the first insertion holes 31D and the plurality of second insertion holes 32D of the two fixing portions 30D are all positioned on the same circumference. However, the first insertion hole 31D and the plurality of second insertion holes 32D of one fixing portion 30D and the first insertion hole 31D and the plurality of second insertion holes 32D of the other fixing portion 30D may be positioned on different circumferences. In other words, a distance from the axis C1 to the first insertion hole 31D and the plurality of second insertion holes 32D of one fixing portion 30D in the radial direction may be different from a distance from the axis C1 to the first insertion hole 31D and the plurality of second insertion holes 32D of the other fixing portion 30D in the radial direction.

The bolt 33 is inserted through the first insertion hole 31D of the first shell 10 and selectively inserted through the plurality of second insertion holes 32D of the second shell 20. That is, the bolt 33 is inserted through the first insertion hole 31D and any one of the second insertion holes 32D. The relative rotation between the first shell 10 and the second shell 20 is restricted by the bolt 33 in a state in which the bolt 33 is inserted through the first insertion hole 31D and the selected second insertion hole 32D.

The nut 34 is inserted through the first insertion hole 31D of the first shell 10 and screwed to the bolt 33 selectively inserted through the plurality of second insertion holes 32D of the second shell 20 to unrotatably fix the first shell 10 and the second shell 20 to each other. Specifically, the nut 34 is screwed to a distal end portion of the shaft portion of the bolt 33 inserted through the first insertion hole 31D of the first shell 10 and the second insertion hole 32D of the second shell 20 to sandwich the first shell 10 (first cover portion 11) and the second shell 20 (second cover portion 21) with the head portion of the bolt 33. By sandwiching the first shell 10 and the second shell 20 between the head of the bolt 33 and the nut 34, the first shell 10 and the second shell 20 are relatively unrotatably fixed to each other.

### Advantages

According to the second embodiment, the same effects as those of the first embodiment are obtained.

According to the second embodiment, the fixing portion 30D includes the plurality of second insertion holes 32D formed in the second shell 20 and arranged at intervals in the circumferential direction centered on the axis, the bolt 33 attached to the first shell 10 and selectively inserted through the plurality of second insertion holes 32D, and the nut 34 screwed to the bolt 33 attached to the first shell 10 and selectively inserted through the plurality of second insertion holes 32D to unrotatably fix the first shell 10 and the second shell 20 to each other.

In such a configuration, the relative rotation of the first shell 10 and the second shell 20 can be restricted only by inserting the bolt 33 attached to the first shell 10 through the selected second insertion hole 32D of the second shell 20. That is, even if the first shell 10 and the second shell 20 are not unrotatably fixed to each other by the nut 34, the relative rotation between the first shell 10 and the second shell 20 can be prevented. Therefore, relative positioning between the first shell 10 and the second shell 20 can be easily performed.

### Modification Example

In the above-described embodiment, the bolt 33 constituting the fixing portion 30D is inserted through the first insertion hole 31D of the first shell 10 and is inserted through the selected second insertion hole 32D of the second shell 20. However, it is sufficient if the bolt 33 is attached to at least the first shell 10 and inserted through the selected second insertion hole 32D of the second shell 20, and the bolt 33 may be provided integrally with the first shell 10, for example. In such a configuration, the first shell 10 does not include the first insertion hole 31D for the bolt 33.

In the above-described embodiment, the plurality of second insertion holes 32D constituting the fixing portion 30D are formed in the second shell 20. However, the plurality of second insertion holes 32D may be formed in the first shell 10, for example. In such a configuration, the first insertion hole 31D for the bolt 33 may be formed in the second shell 20, or the bolt 33 may be provided integrally with the second shell 20.

### Other Modified Example

In each of the above-described embodiments, the first shell 10 has the arc-shaped inner surface 12b centered on the axis C1, and the second shell 20 has the arc-shaped outer surface 22b centered on the axis C1. However, for example, the first shell 10 may have an arc-shaped outer surface, and the second shell 20 may have an arc-shaped inner surface. It is sufficient if the arc-shaped outer surface and the arc-shaped inner surface come into surface contact with each other and slide in the circumferential direction D1 about the axis C1. Even with such a configuration, the same effects as those of each of the above-described embodiments are obtained.

In each of the above-described embodiments, the first side wall 12 of the first shell 10 has the first inner side surface 12a. However, the first side wall 12 does not have to have the first inner side surface 12a, for example.

In each of the above-described embodiments, the first shell 10 includes the first cover portion 11 and the first side wall 12. However, the first shell 10 only needs to include at least the first cover portion 11, and does not have to include, for example, the first side wall 12.

In each of the above-described embodiments, the second side wall 22 of the second shell 20 has the second inner side surface 22a. However, the second side wall 22 does not have to have the second inner side surface 22a, for example.

In each of the above-described embodiments, the second shell 20 includes the second cover portion 21 and the second side wall 22. However, the second shell 20 only needs to include at least the second cover portion 21, and does not have to include the second side wall 22, for example.

In each of the above-described embodiments, the electric wire 2 is directly connected to the terminal 4 of the connector 3. However, the electric wire 2 does not have to be directly connected to the terminal 4 of the connector 3. For example, a bus bar (conductive member) may be connected to the terminal 4 of the connector 3, and the electric wire 2 may be connected to the terminal 4 via the bus bar. In this case, only the bus bar may be accommodated in the conductive member accommodating portion 52 of the housing 5, or the bus bar and a part of the electric wire 2 connected thereto may be accommodated in the conductive member accommodating portion 52 of the housing 5.

One embodiment and modified examples have been described above. However, the embodiment and the modified examples are not limited to the examples described above. For example, the embodiment and the modified examples may be implemented in combination with each other.

### REFERENCE SIGNS LIST

2 Electric wire (conductive member)
3 Connector
4 Terminal
5 Housing
6 Shell
10 First shell
12b Arc-shaped inner surface
20 Second shell
22b Arc-shaped outer surface
30 Fixing portion
32 Long hole
32D Second insertion hole (insertion hole)
33 Bolt
34 Nut
51 Terminal accommodating portion
52 Conductive member accommodating portion
53 Opening
531 First opening
532 Second opening
C1 Axis
D1 Circumferential direction

What is claimed is:

1. A shell for being attached to a housing, the housing including a terminal accommodating portion that accommodates a terminal, a conductive member accommodating portion that is disposed adjacent to the terminal accommodating portion so as to be immovable and accommodates a part of a conductive member extending from the terminal, and an opening that opens the terminal accommodating portion and the conductive member accommodating portion to an outside in a first intersecting direction intersecting an arrangement direction of the terminal accommodating portion and the conductive member accommodating portion, the shell comprising:
a first shell that covers, among the opening, at least a first opening corresponding to the terminal accommodating portion; and
a second shell that covers, among the opening, at least a second opening corresponding to the conductive member accommodating portion,
wherein the first shell and the second shell are rotatable relative to each other about an axis extending in the first intersecting direction, and
wherein the shell further comprises a fixing portion that unrotatably fixes the first shell and the second shell to each other at a position away from the axis in a radial direction.

2. The shell according to claim 1, wherein a plurality of the fixing portions are arranged at intervals in a circumferential direction around the axis.

3. The shell according to claim 1,
wherein the fixing portion includes:
an arc-shaped long hole that is formed in one of the first shell and the second shell and extends in a circumferential direction around the axis;
a bolt that is attached to the other one of the first shell and the second shell and inserted through the long hole; and
a nut that unrotatably fixes the first shell and the second shell to each other by being attached to the other one of the first shell and the second shell and being screwed to the bolt inserted through the long hole.

4. The shell according to claim 1,
wherein the fixing portion includes:
a plurality of insertion holes that are formed in one of the first shell and the second shell and arranged at intervals in a circumferential direction around the axis;
a bolt that is attached to the other one of the first shell and the second shell and selectively inserted through one of the plurality of insertion holes; and
a nut that unrotatably fixes the first shell and the second shell to each other by being attached to the other one of the first shell and the second shell and being screwed to the bolt selectively inserted through the one of the plurality of insertion holes.

5. The shell according to claim 1,
wherein one of the first shell and the second shell has an arc-shaped inner surface centered on the axis,
wherein the other one of the first shell and the second shell has an arc-shaped outer surface centered on the axis, and
wherein the arc-shaped inner surface and the arc-shaped outer surface come into surface contact with each other and slide in a circumferential direction around the axis.

6. A connector comprising:
a terminal;
a housing including a terminal accommodating portion that accommodates the terminal, a conductive member accommodating portion that is disposed adjacent to the terminal accommodating portion so as to be immovable and accommodates a part of a conductive member extending from the terminal, and an opening that opens the terminal accommodating portion and the conductive member accommodating portion to an outside in a first intersecting direction intersecting an arrangement direction of the terminal accommodating portion and the conductive member accommodating portion; and
the shell according to claim 1.
